(19) United States
(12) Patent Application Publication
(10) Pub. No.: US 2026/0274143 A1
(43) Pub. Date: Sep. 17, 2026

(54) PACKAGE HANDLING SYSTEM AND METHODS OF USE

(71) Applicant: Mathew L. Grell, Norcross, GA (US)

(72) Inventor: Mathew L. Grell, Norcross, GA (US)

(21) Appl. No.: 19/680,269

(22) Filed: May 18, 2026

Related U.S. Application Data
(63) Continuation of application No. 19/675,201, filed on May 12, 2026.
Application No. 19/675,201 is a continuation-in-part of application No. 19/324,584, filed on Sep. 10, 2025.
Application No. 19/324,584 is a continuation of application No. 18/308,744, filed on Apr. 28, 2023, now Pat. No. 12,427,903.
(60) Provisional application No. 63/363,856, filed on Apr. 29, 2022.

(51) Int. Cl. B60P 1/00; B60P 3/00; B64U 20/00; B64U 101/64

(52) U.S. Cl. CPC B60P 1/00; B60P 3/00; B64U 20/00; B64U 2101/64

(57) ABSTRACT

A package handling system and methods of use provide fully automated last-mile drone delivery from a delivery truck. One or more delivery packages containing ordered widgets are pre-affixed in exact delivery-route sequence to a continuous package feed tape to form a flexible delivery package chain. A feed tape mechanism on the truck (or on a palletized bin) propels the chain toward a drone platform having a pair of spaced-apart landing pads. A drone lands on the platform; its drone feed tape capture system engages the feed tape and the next package; a controller-activated tape cutter severs the package from the chain; and the drone flies the package directly to the customer's porch, garage, drop box, or other designated location. The system further includes an automated battery replacement subsystem that uses a parallel battery feed tape to swap spent drone batteries without interrupting flight operations. Warehouse package-chain equipment robotically places widgets onto a lower film layer, overlays an upper film layer, heat-seals individual packages, and forms partial severances while preserving continuous outer edges of the feed tape, thereby creating a hinged, arcuate-feed-capable chain that can be compactly coiled or fed vertically through a vehicle aperture. Envelope-flap embodiments enable in-line self-filling. The integrated truck-drone system eliminates manual package selection, reduces manpower and delivery time, and prevents sequencing errors.

### CROSS-REFERENCE TO RELATED APPLICATIONS

This application is a Continuation-in-Part of U.S. application Ser. No. 19/675,201 filed on May 12, 2026, entitled “Package Handling System and Methods of Use”, which is a Continuation-in-Part of and hereby claims priority to and the full benefit of, U.S. application Ser. No. 19/324,584, filed on Sep. 10, 2025, entitled “PACKAGE HANDLING SYSTEM AND METHODS OF USE”, which is a Continuation of U.S. application Ser. No. 18/308,744 filed on Apr. 28, 2026 (now U.S. Pat. No. 12,427,903 issued on Sep. 30, 2025), entitled “PACKAGE HANDLING SYSTEM AND METHODS OF USE”, which claims the benefit of U.S. Application No. 63/363,856, filed on Apr. 29, 2022, entitled “PACKAGE HANDLING SYSTEM AND METHODS OF USE”. The foregoing is incorporated herein by reference in its entirety.

### FIELD OF THE DISCLOSURE

The present disclosure is directed at the delivery of packages. More specifically, the present disclosure is directed to a system to bundle packages at warehouse, deliver by truck to curb, and drone to porch.

### BACKGROUND

Logistics and e-commerce era package delivery entails regional warehouses of products in storage ready for purchase and quick delivery to customer designated address. More specifically, these warehouses are massive and highly organized facilities that house millions of products across hundreds of categories. These products are managed and processed by proprietary software, which allows for rapid fulfillment and delivery of orders. Once a customer places an order, the warehouse staff quickly locates the relevant product and prepares it for shipment. These businesses rely on an extensive logistics network for its delivery operations, including trucking, delivery vehicles and last-mile delivery services. This allows logistics and e-commerce businesses to offer a wide range of shipping speeds, from same-day delivery to standard shipping times of just a few days. Overall, these warehouse and delivery operations are incredibly efficient and well-run.

One disadvantage with conventional warehouse systems is packages are not linked together in order of delivery from first delivery to last delivery for a given vehicle route requiring drivers to select delivery packages at each stop.

Another disadvantage with conventional delivery is if drones are utilized the drone must enter the enclosed vehicle, identify the package to be delivered, pick the package up, and maneuver out of the enclosed vehicle to deliver the package.

Therefore, it is readily apparent that there is a recognizable unmet need for a package handling system and methods of use that may be configured to address at least some aspects of the problems discussed above.

### SUMMARY

Briefly described, in an example embodiment, the present disclosure may overcome the above-mentioned disadvantages and may meet the recognized need for package handling system and methods of use may include a truck and drone delivery system having one or more drones, a delivery truck, the delivery truck having one or more drone platforms. The delivery truck may include one or more catch bins or containers to catch undeliverable packages and/or used battery packs. The drone platforms may include at least a pair of spaced apart landing pads for the one or more drones. The truck or bins may house and transport at least one set of delivery packages affixed in series to a feed tape according to a sequence in a delivery route (delivery package feed tape mechanism and tape cutter). The feed tape may be fed into a feed tape mechanism and tape cutter. A microprocessor or controller controls feed tape mechanism (such as with drive wheels) and tape cutter may be engaged based on the position in a route (GPS) via a reader reading a code, such as a bar code on the feed tape or delivery package and confirms package delivery and GPS location or position. Drone lands on drone pad. Processor or controller detects drone is in positions on drone platform. The feed tape mechanism gripping(s) the feed tape and propels the feed tape and delivery package (n) to the drone platform and preferably between the pair of spaced apart landing pads. Drone with tape capture mechanism receives feed tape and delivery package (n) in its drone tape capture mechanism. Drone communicates to Processor or controller that feed tape and delivery package (n) is secure in drone tape capture mechanism. Processor or controller initiates tape cutter to cut feed tape segment of delivery package (n) from remaining feed tape. Drone lifts off drone pad and delivers feed tape segment and delivery package (n) to addressed delivery location (n), such as front door, garage (drone trigger garage to open & close), porch, drop box, or other designated location. Drone returns to drone platform to pick up feed tape and delivery package (n+1). Delivery truck moves to address (n+1). Repeat.

Alternate embodiment drone platform and delivery package feed tape mechanism and tape cutter may be positioned in an interior of the delivery truck.

Alternate embodiment drone platform and delivery package feed tape mechanism and tape cutter may be positioned on a container or bin and may be on a pallet that a fork truck moves into an interior or platform of the delivery truck.

Accordingly, in another aspect, the present disclosure may include a battery pack replacement system. The battery pack replacement system may include one or more drones, a delivery truck, the delivery truck having one or more drone platforms. The delivery truck may include one or more catch bins or containers to catch used batteries. The truck or bins may house at least one set of drone replacement batteries (battery pack) affixed in series to a feed tape. The feed tape may be fed into a drone battery feed tape mechanism and tape cutter. A microprocessor or controller controls drone battery feed tape mechanism and tape cutter based on drone power levels. Drone lands on drone pad. Processor or controller detects drone is in positions on drone platform and drone is low on power. The drone battery feed tape mechanism and tape cutter gripping(s) the feed tape and propels the feed tape and drone battery (n) to the drone platform. Drone with battery tape capture mechanism receives feed tape and drone battery (n) in its drone battery tape capture mechanism. Drone communicates to Processor or controller that feed tape and drone battery (n) is secure in drone battery tape capture mechanism. Drone may be powered via drone platform contact leads during drone battery swap out time period. Old or spent drone battery (n−1) is pushed from drone battery receiver by drone battery tape capture mechanism and drops or is captured in catch bin to catch discarded drone batteries and new battery (n) is inserted into drone battery receiver.

Accordingly, in another aspect, the present disclosure may include feed tape and delivery package fill system. Feed tape and delivery package fill system may be utilized to fill and seal the packages and affix to a feed tape or fill and seal the packages affixed in series to a feed tape according to delivery route using a delivery package feed tape mechanism to position each package in a loading terminal to enable the drone or robot to place or drop purchased item(s) into a package according to a delivery route. Then print and affix labels and codes such as bar codes to the package. These functions may occur in a warehouse or factory.

In an exemplary embodiment of a package handling system for delivery of a widget ordered and destined for a delivery stop on a delivery route, having one or more delivery packages affixed in series to a package feed tape, a feed tape mechanism, the feed tape mechanism configured to engage the package feed tape to propel the package feed tape and the one or more delivery packages affixed thereto, a tape cutter to cut the package feed tape to separate at least one delivery package from the one or more delivery packages, a drone platform positioned proximate the tape cutter, and a drone having a drone feed tape capture system to receive the package feed tape and the at least one delivery package of the one or more delivery packages affixed to the package feed tape.

In a second exemplary embodiment of an a battery handling system, having one or more batteries affixed in series to a battery feed tape, a battery feed tape mechanism, the battery feed tape mechanism configured to engage the battery feed tape to propel the battery feed tape and the one or more batteries affixed thereto, a tape cutter to cut the battery feed tape to separate at least one battery from the one or more batteries, a drone platform positioned proximate the tape cutter, and a drone having a drone feed tape capture system to receive the battery feed tape and the at least one battery from the one or more batteries affixed to the battery feed tape.

In a third exemplary embodiment of an envelope filling system, having one or more envelopes affixed in series to a feed tape, the feed tape having a series of feed apertures, a feed tape mechanism, the feed tape mechanism configured to engage the series of feed apertures of the feed tape to propel the feed tape and the one or more envelopes affixed thereto, a tape cutter to cut feed tape to separate one or more envelopes from the one or more envelopes, a robotic arm positioned proximate the feed tape mechanism, and at least one collection of widgets positioned proximate the robotic arm wherein the robotic arm picks a designated widget associated with a delivery address in a sequence of a delivery route and places the designated widget in an envelope from the one or more envelopes to form a delivery package in a sequence of delivery packages.

It is an object of the disclosure herein to enable drone pickup and delivery of one or more packages destined for an address from multiple packages affixed in series to a feed tape.

It is an object of the disclosure herein to reduce manpower cost in a warehouse and delivery personnel to deliver packages.

It is an object of the disclosure herein to enable swap out spent drone battery/batteries with a new battery/batteries from multiple drone batteries affixed in series to a feed tape automatically while on the drone platform.

A feature of the present disclosure includes the advantage of using truck and drone delivery system drones to deliver package. Drones can significantly reduce delivery times, as they can travel directly to the customer's doorstep from the truck rather than relying on high cost human ground transportation methods. This means that customers can receive their packages much faster and at lower costs, which can be especially beneficial for time-sensitive deliveries.

A feature of the present disclosure includes the advantage of using battery pack replacement system enables field replacement of drone battery systems significantly reduce delivery times by keeping drones in operation verses stopping to charge drone battery systems.

A feature of the present disclosure includes the advantage of using feed tape and delivery package fill system where packages are affixed to a tape feed in sequence matching delivery stops along a delivery route. Packages affixed to a tape feed in sequence matching delivery stops along a delivery route can significantly reduce delivery times and reduce incorrect deliveries. This means that customers can receive their packages much faster and more accurately, which can be especially beneficial for time-sensitive deliveries.

A feature of the present disclosure includes using drones for delivery of packages can also help to lower delivery costs. Traditional delivery methods often require multiple personnel and vehicles to make a single delivery, which can be costly and time-consuming. Drones, robots, and self-driving vehicles on the other hand, have low overhead operating costs and can make deliveries more efficiently and quickly.

A feature of the present disclosure includes packages affixed in series to a feed tape according to delivery route.

A feature of the present disclosure includes a delivery package feed tape mechanism and tape cutter.

A feature of the present disclosure includes a drone platform with spaced landing pads.

A feature of the present disclosure includes a drone with drone or package tape capture mechanism.

A feature of the present disclosure includes drone battery pack(s) affixed in series to a battery feed tape.

A feature of the present disclosure includes drone battery feed tape mechanism and tape cutter.

A feature of the present disclosure includes a catch bin to catch discarded drone batteries or undeliverable packages.

A feature of the present disclosure includes propelling the package chain vertically through an aperture in vehicle ceiling.

A feature of the present disclosure includes flexible package chain and self-fill packages.

These and other features of package handling system and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for package handling system and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1 is a perspective cutout view of a delivery truck transporting one or more packages, destined for an address as delivery package (Pn) and addresses for delivery package (Pn+1, Pn+2. . . . ), from multiple packages affixed in series to a feed tape, a feed tape mechanism and cutter, a drone platform, a catch bin, according to select embodiments of the instant disclosure;

FIG. 2 is a perspective view of feed tape mechanism for one or more packages and tape cutter shown with feed tape fed into feed tape mechanism holding in series delivery package (Pn) and delivery package (Pn+1, Pn+2. . . . ), tape cutter, and a drone platform, according to select embodiments of the instant disclosure;

FIG. 2A is a front view of feed tape mechanism for one or more packages and tape cutter shown with feed tape fed vertically into feed tape mechanism holding in series delivery package (Pn) and delivery package (Pn+1, Pn+2. . . . ), tape cutter, and vehicle aperture, according to select embodiments of the instant disclosure;

FIG. 2B is a top view of an alternate delivery package chain, according to select embodiments of the instant disclosure;

FIG. 2C is a top view of another alternate delivery package chain, according to select embodiments of the instant disclosure;

FIG. 3 is a perspective view of feed tape mechanism for one or more packages and tape cutter shown with feed tape fed into feed tape mechanism holding in series delivery package (Pn) and delivery package (Pn+1, Pn+2. . . . ), tape cutter, and a drone platform, according to select embodiments of the instant disclosure, shown in a container on a palate;

FIG. 4A is a perspective view of the drone in flight around drone platform of FIGS. 1-3, according to select embodiments of the instant disclosure;

FIG. 4B is a side view of drone in flight carrying package in route to a delivery address transporting a package from the drone platform, according to select embodiments of the instant disclosure;

FIG. 5 is a perspective cutout view of a delivery truck transporting one or more batteries, battery (Bn) and batteries (Bn+1, Bn+2. . . . ) to power drone(s) affixed in series to a feed tape, a feed tape mechanism and cutter, drone battery feed tape capture system, a drone platform, a catch bin, according to select embodiments of the instant disclosure;

FIG. 5A is a perspective view of feed tape mechanism for one or more batteries and tape cutter shown with feed tape fed into feed tape mechanism holding in series one or more batteries, battery (Bn) and batteries (Bn+1, Bn+2. . . . ) to power drone(s), tape cutter, and a drone platform, according to select embodiments of the instant disclosure;

FIG. 5B is a side view of drone in flight carrying with fresh set of batteries, according to select embodiments of the instant disclosure;

FIG. 6 is an exploded view of feed tape mechanism and tape cutter shown with feed tape fed into feed tape mechanism holding in series delivery envelopes (En), and tape cutter, robot, or robotic arm to stuff envelope En and envelopes (En+1, En+2. . . . ) with customer purchased content, such as collection of widgets Wn and widgets (Wn+1, Wn+2. . . . ) to make delivery package (Pn) and delivery packages (Pn+1, Pn+2. . . . ) for delivery to designated addresses in a route, according to select embodiments of the instant disclosure;

FIG. 6A is a side perspective view of the package chain equipment of the feed tape and delivery package fill system, according to select embodiments of the instant disclosure;

FIG. 7 is a map of a delivery route having a series of delivery stops associated with designated delivery packages for each stop or address in a sequence of a delivery route; and

FIG. 8 is a flowchart.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples, and are merely examples among other possible examples. It is recognized herein that the optimum dimensional relationships, to include variations in size, materials, shape, form, position, connection, function and manner of operation, assembly and use, are intended to be encompassed by the present disclosure.

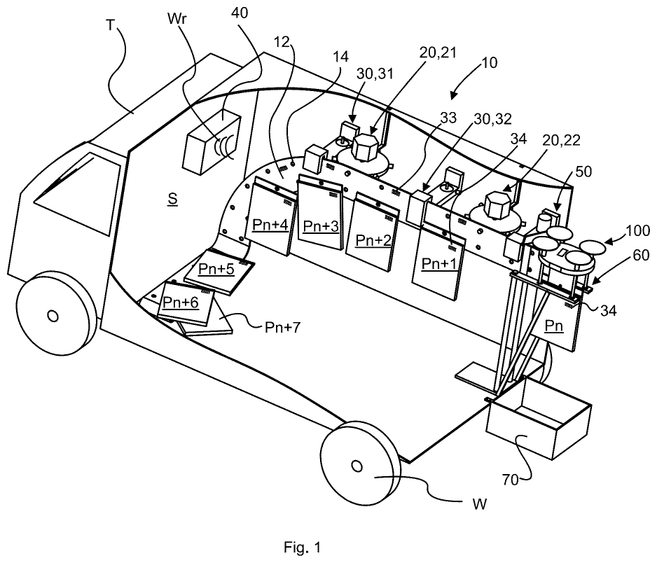

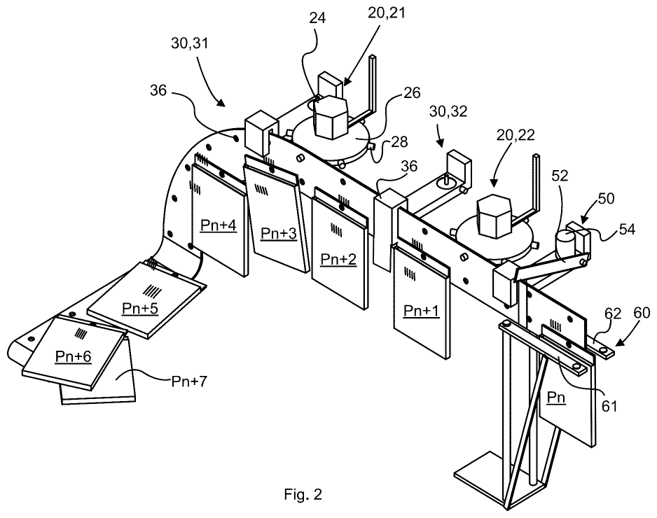

Referring now to FIGS. 1, 2, and 3, there is illustrated a preferred embodiment of package handling system 10 integrated with manned or unmanned delivery vehicle, such as delivery truck T transporting one or more delivery packages P (each containing a product or widget Wn) or one or more sets of delivery packages P destined for a set of address on a route, such as delivery route DR having a series of package drops, such as delivery stops DS of one or more packages, such as delivery packages Pn, Pn+1, Pn+2, Pn+3, Pn+4, Pn+5, Pn+6, Pn+7, and so on affixed or removably affixed in series to a package feed tape, such as package feed tape 12 being transported to individual addresses or delivery stops DS along delivery route DR. Each package P may contain an address or machine readable code 34, such as a bar code or RFID tag (package information) that can be scanned by code reader, such as package reader 30, 31, 32 to designate a section or segment of package feed tape 12, which has package P affixed thereto, and transmit such information to microprocessor or controller 40 to control delivery or hand off of packages P affixed to package feed tape 12 to drone platform 60.

Ribbon, such as package feed tape 12 may include a plurality of holes, rows of, gripping teeth, or series of feed tape apertures 14 and one or more delivery packages P may be affixed or removably affixed in series to package feed tape 12 or one or more delivery packages P may be pivotably affixed or removably affixed in series to package feed tape 12. Package feed tape 12 (or feed tape 12) may contain an address or machine readable code 33, such as bar code or RFID tag (package information) that can be scanned by machine code reader, such as tape reader 30, 31, 32 and transmitted to microprocessor or controller 40 to control, determine, delineate delivery of packages P affixed to package feed tape 12 to drone platform 60 or control, determine, delineate one delivery package P of one or more delivery packages Pn (Pn+1, Pn+2, Pn+3, Pn+4, Pn+5, Pn+6, Pn+7) affixed to package feed tape 12.

It is contemplated that in order to precisely drive package feed tape 12 then package feed tape 12 may be configured with a gripping surface to prevent slippage of feed tape drive mechanism.

Package feed tape 12 may be fed into feed tape mechanism 20, 21, 22 affixed to, for example, sidewall S of delivery truck T and configured to drive, push and pull, or move (to propel) feed tape 12 in preferably linear motion toward drone platform 60. Package feed tape 12 may be fed into feed tape mechanism 20 and tape cutter 50 to start the sequence of package feed tape 12. Moreover, package handling system 10 may include delivery microprocessor or controller 40 controls(ing) feed tape mechanism 20, 21, 22 having drive motor 24, connected to drive wheel 26, having for example plurality of pins or pegs 28 positioned on a perimeter of drive wheel 26 to engage feed tape apertures 14 of package feed tape 12 to feed delivery packages Pn, Pn+1, Pn+2, Pn+3, Pn+4, Pn+5, Pn+6, Pn+7 to drone platform 60 and unmanned aerial vehicle, such as drone 100 according to a sequence in delivery route DR and pre-loaded with contents according to such sequence of delivery stops DS in a delivery route DR of delivery truck T (delivery stop sequence).

Microprocessor or controller 40 to control(s) feed tape mechanism 20, 21, 22 based on predetermined delivery route DR of delivery truck T route (confirmed by GPS location or position) and sequence, or series of delivery packages Pn, Pn+1, Pn+2, Pn+3, Pn+4, Pn+5, Pn+6, Pn+7 being pre-loaded with widgets Wn according to such delivery sequence of delivery stops DS in delivery route DR of delivery truck T (delivery stop sequence) and confirmed by microprocessor or controller 40, which controls package reader 30, 32, tape reader 30, 31 having machine code reader 36 positioned proximate or close in distance package feed tape 12 to enable reading of machine readable code 33, 34, feed tape mechanism 20, 21, 22 and together with delivery truck T, GPS location or position and sequence in delivery stops DS of delivery route DR to control, determine, or delineate one delivery package P of delivery packages Pn (Pn+1, Pn+2, Pn+3, Pn+4, Pn+5, Pn+6, Pn+7) to be delivered to delivery stops DS in delivery route DR.

It is contemplated herein that feed tape mechanism 20, 21, 22 may be utilized in a reverse feed via feed tape mechanism 20, 21, 22 to automatically load delivery truck T with delivery packages Pn, Pn+1, Pn+2, Pn+3, Pn+4, Pn+5, Pn+6, Pn+7 being pre-loaded with widgets Wn according to such delivery sequence of delivery stops DS in delivery route DR of delivery truck T.

Package handling system 10 may further include tape separator or tape cutter 50 having cutter mechanism 52 and drive mechanism 54 positioned proximate or close in distance package feed tape 12. Microprocessor or controller 40 controls tape cutter 50 based on predetermined delivery truck T route (confirmed by GPS location or position), delivery stops DS of delivery route DR, and sequence of series of delivery packages Pn, Pn+1, Pn+2, Pn+3, Pn+4, Pn+5, Pn+6, Pn+7 being pre-loaded with contents, such as widget Wn, according to such sequence of delivery stops DS of delivery route DR of delivery truck T and confirmed by delivery microprocessor or controller 40, which controls tape cutter 50 to cut, separate, release, or sever, for example, delivery package Pn from delivery packages Pn+1, Pn+2, Pn+3, Pn+4, Pn+5, Pn+6, Pn+7 to enable transfer of delivery package Pn to unmanned aerial vehicle, such as drone 100, which may be configured to pick up package Pn, and thereafter respectively next Pn+1 from Pn+2, Pn+3, Pn+4, Pn+5, Pn+6, Pn+7 and so on in sequence and deliver each delivery package Pn to such sequence of delivery stops DS of delivery route DR of delivery truck T (delivery stop sequence).

Package handling system 10 may further include one or more unmanned aerial vehicle platforms, such as drone platform 60, preferably having pair of spaced apart landing pads 61, 62 to enable delivery package Pn to be sequentially delivered one by one or combinations of delivery packages Pn and Pn+1 by microprocessor or controller 40, feed tape mechanism 20, and tape cutter 50 between landing pads 61, 62 positioned proximate or close in distance to feed tape mechanism 20, and tape cutter 50. Microprocessor or controller 40 controls tape cutter 50 based on predetermined delivery truck T route (confirmed by GPS location or position) and sequence of series of delivery packages Pn, Pn+1, Pn+2, Pn+3, Pn+4, Pn+5, Pn+6, Pn+7 being pre-loaded with contents, such as widget Wn, according to such sequence of delivery stops DS of delivery route DR of delivery truck T and confirmed by microprocessor or controller 40 controls tape cutter 50 to cut, separate, release, or sever, for example, delivery package Pn from delivery packages Pn+1, Pn+2, Pn+3, Pn+4, Pn+5, Pn+6, Pn+7 to enable unmanned aerial vehicle, such as drone 100 to pick up of package Pn, and thereafter respectively next Pn+1 from Pn+2, Pn+3, Pn+4, Pn+5, Pn+6, Pn+7 and so on in sequence therefrom landing pads 61, 62 to deliver delivery packages Pn in sequence to delivery stops DS of delivery route DR of delivery truck T (delivery stop sequence).

It is contemplated that delivery truck T may include a container, such as catch bin 70 affixed to delivery truck T to enable drone 100 to deposit package Pn that is not deliverable (undeliverable) so delivery truck T and drone 100 can move on to the next delivery stop DS for delivery package Pn+1.

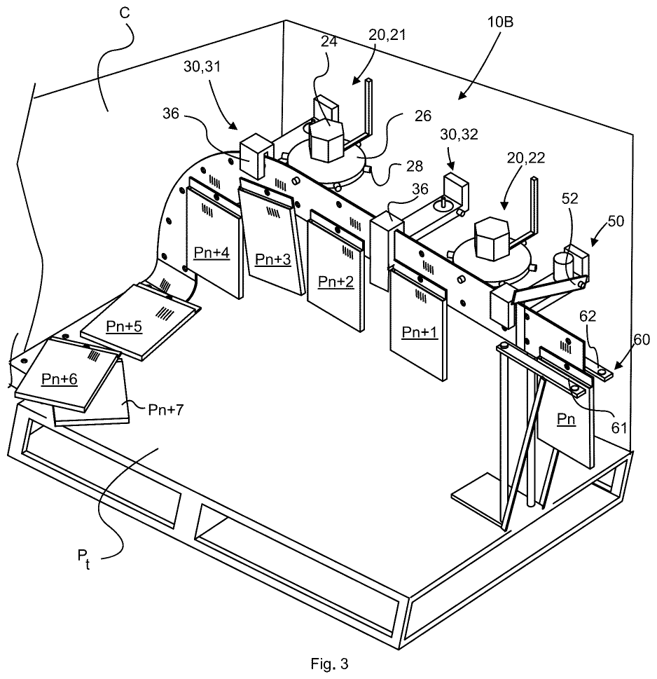

It is contemplated herein in FIG. 3 that package handling system 10B may be housed in or on packager or container C and positioned on palate Pt or just positioned on palate Pt for moving via a fork truck to load one or more package handling system 10B onto delivery truck T.

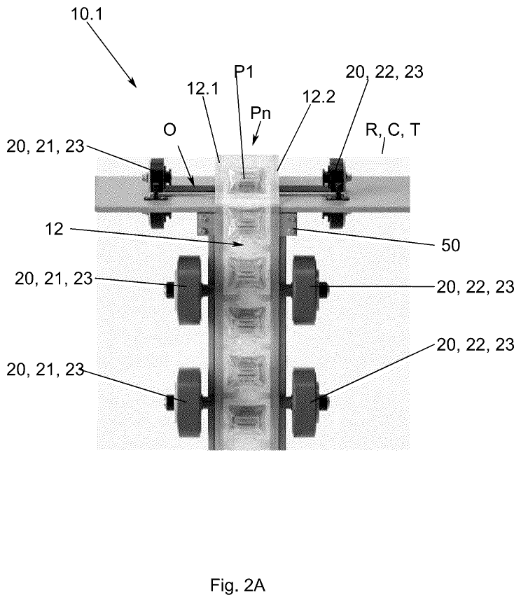

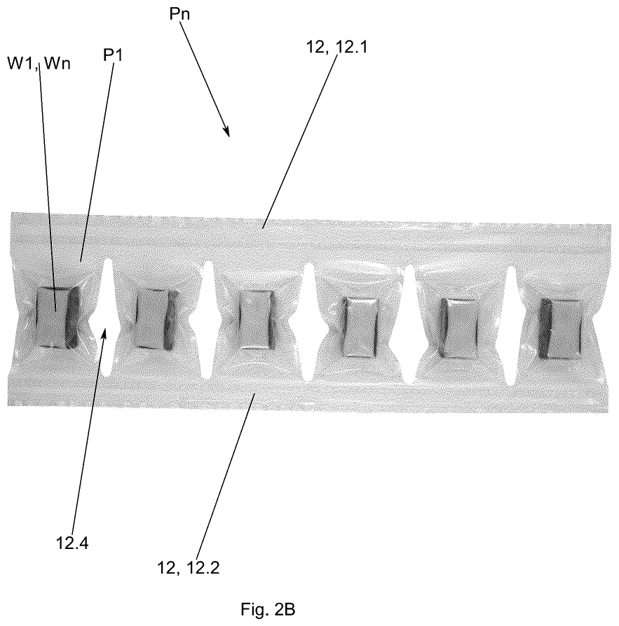

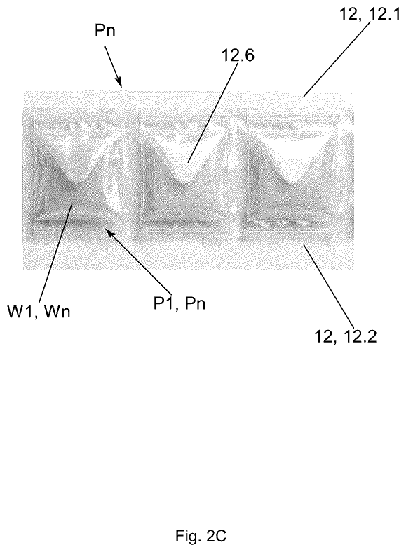

Referring now to FIG. 2A, there is illustrated an alternate preferred embodiment of the package handling system 10.1 of the present disclosure. In this embodiment, the feeding of one or more adjacent delivery packages Pn (and the attached series Pn+1, Pn+2, . . . ) is accomplished by propelling package feed tape 12 vertically upward through ceiling C of delivery vehicle T. Ceiling C is preferably provided with vehicle opening/aperture O sized to permit passage of package feed tape 12 and affixed delivery packages Pn therethrough to exterior drone platform 60 (shown in FIG. 2) positioned on or above roof R of the delivery vehicle T.

Package feed tape 12 is oriented vertically within the interior of delivery vehicle T and carries delivery packages Pn, Pn+1, Pn+2, . . . in the pre-determined delivery-route sequence described herein. One or more feed tape mechanisms 20, 21, 22 (collectively the drone package feeder) are mounted proximate ceiling C, roof R of the delivery vehicle T and are configured to engage and propel package feed tape 12 by contacting at least one outer edge, such as first outer edge 12.1and second outer edge 12.2 (and preferably both opposing outer edges extend unbroken along the full length of the chain of delivery packages Pn) of the package feed tape 12. In the illustrated embodiment, feed tape mechanisms 20, 21, 22 include a plurality of package drives (such as hole catch, friction, or geared drive wheels or rollers) positioned on opposing sides of feed tape 12. These drive wheels or rollers 23 grip outer longitudinal edges, such as first outer edge 12.1 and second outer edge 12.2, of the package feed tape 12 (or the edges of an associated package chain portion thereof) and rotate to impart linear upward motion to the entire tape-and-package assembly or engage of linear feed apertures 14.

This edge-contact propulsion constitutes a key feature of the present embodiment, enabling reliable, high-torque vertical feeding through the ceiling aperture while minimizing wear on any central tape perforations and allowing package feed tape 12 to remain vertical and stable as it passes through the confined vehicle opening.

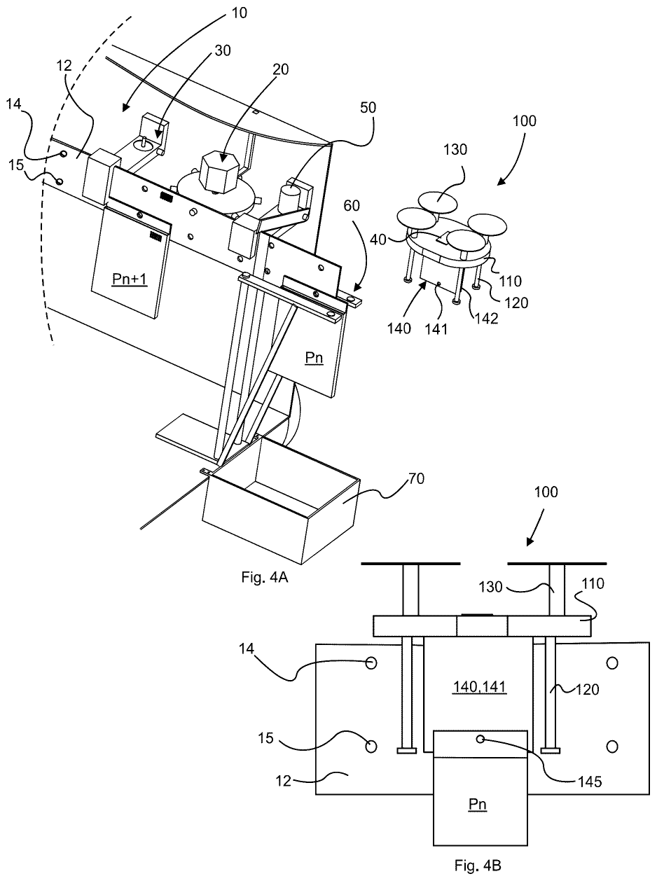

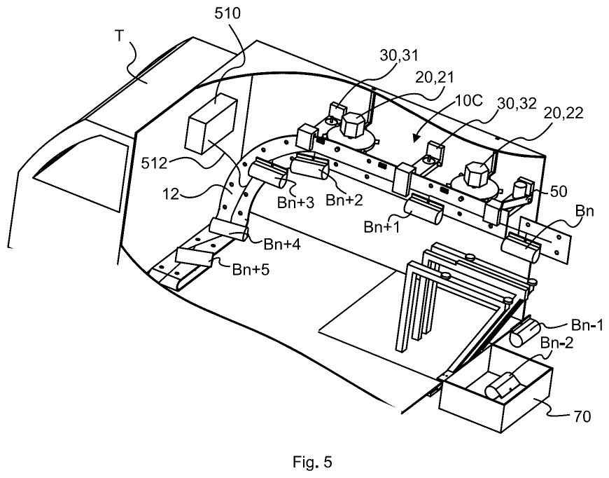

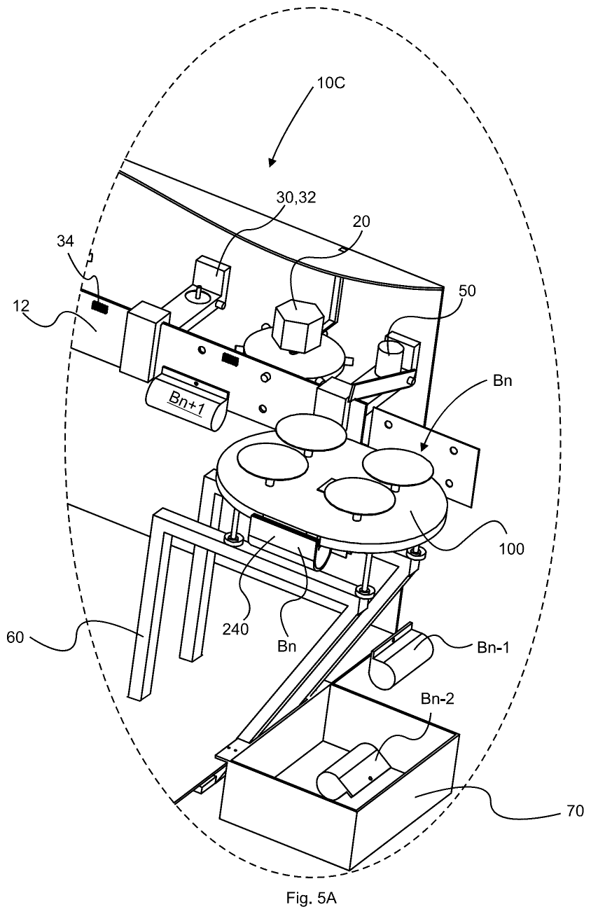

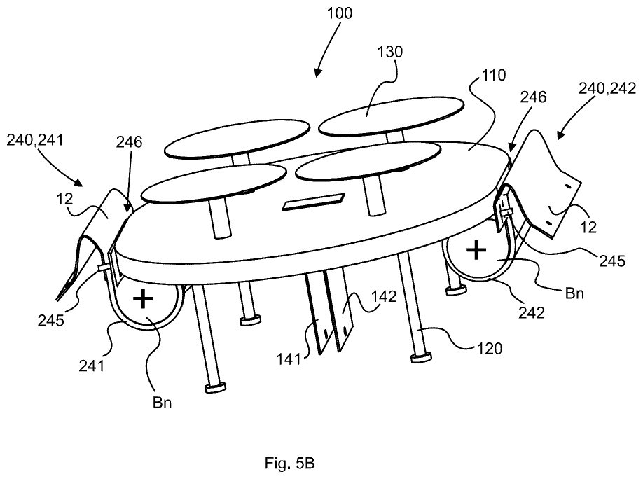

As the uppermost delivery package Pn reaches vehicle opening O in ceiling C, it emerges onto or immediately adjacent drone platform 60 (shown in FIGS. 1 and 2) located exterior to delivery vehicle T. Drone 100 (shown in FIGS. 4A and 5A) lands on the spaced-apart landing pads 61, 62 of the drone platform 60. Drone feed tape capture system 140 (including catch pin 145) then engages package feed tape 12 and/or delivery package Pn in the manner previously described. Once drone 100 signals secure capture to the microprocessor/controller 40, the tape cutter 50 (positioned proximate feed tape mechanism 20, 21, 22 or on platform 60) severs feed tape 12, releasing the individual segment carrying delivery package Pn. Drone 100 then lifts off and delivers package Pn to the designated delivery stop DS on the delivery route DR.

The remaining packages Pn+1, Pn+2, . . . continue to be advanced upward by the edge-contacting feed tape mechanisms 20, 21, 22 in precise sequence as the delivery vehicle T proceeds along the delivery route DR (guided by GPS and the machine-readable codes 33, 34 read by readers 30, 31, 32 shown in FIG. 1). The vertical, through-ceiling feed path allows drone platform 60 to remain on the exterior roof of the vehicle T, thereby protecting the interior cargo space, facilitating rapid drone access without requiring drone 100 to enter the vehicle interior, and providing improved weather and security isolation for both the packages and the feed mechanism.

It is contemplated herein that feed tape mechanisms 20, 21, 22 may operate in forward or reverse directions, enabling both unloading of packages for drone delivery and automated loading of pre-sequenced packages into the delivery vehicle T through the same ceiling aperture C. The edge-contact design further allows the system to accommodate varying package widths and thicknesses while maintaining positive control of the feed tape 12 during vertical transit. All other components and operational steps of the package handling system 10 (controller 40, GPS integration, drone battery handling, envelope-filling station, etc.) remain fully compatible with this through-ceiling embodiment.

This ceiling-feed configuration, in combination with the edge-contacting feed tape mechanism 20, 21, 22, provides the disclosed advantage of streamlined, non-intrusive package transfer from the protected interior of delivery vehicle T directly to the exterior drone platform 60, further reducing delivery times, minimizing driver intervention, and enhancing overall system efficiency.

It is contemplated herein that package handling system 10, 10.1 may fed horizontal, vertical, angled, on an arc, or otherwise.

Referring now to FIG. 2B, there is illustrated an alternate preferred embodiment of the delivery package P1 and the associated delivery package chain Pn of the package handling system 10 of the present disclosure. In this embodiment, each individual delivery package, such as delivery package P1 (containing a delivery item W1, Wn) is formed as part of a continuous delivery package chain Pn in which a plurality of sealed packages Pn, Pn+1, Pn+2, . . . are affixed or integrated with in series to package feed tape 12. Package feed tape 12 is configured as a double-sealed feed tape having at least one intact outer edge (and preferably two opposing longitudinal outer edges, such as first outer edge 12.1 and second outer edge 12.2) that may remain fully continuous along the entire length of delivery package chain Pn. Between each adjacent pair of sealed package Pn and Pn+1 (and so on-plurality of sealed delivery packages Pn), the packaging material may be provided with a slit between first outer edge 12.1 and second outer edge 12.2 or cut of one or both first outer edge 12.1 and second outer edge 12.2, as severance 12.4 (shown as a clean cut or perforation line extending inwardly from outer packaging edges toward center of feed tape 12 but terminating precisely at or immediately adjacent feed tape 12 itself). This severance 12.4 leaves the feed tape 12 completely intact and unsevered, thereby creating a flexible hinge or living hinge at each inter-package junction of the flexible delivery package chain Pn. The combination of the continuous outer edge(s) of the package feed tape 12 and the strategically placed severance 12.4 constitutes a feature of the present embodiment. Because feed tape 12 remains uncut at the hinge line, each individual delivery package Pn is able to independently hinge, pivot, and flex relative to the adjacent package Pn+1 while the entire delivery package chain Pn remains securely connected. This hinged flexibility permits the delivery package chain Pn to follow an arcuate or curved feed path through feed tape mechanism 20, 21, 22 (as illustrated in the curved routing shown in the earlier figures) without binding, buckling, or requiring excessive force. The same hinged design also enables the entire delivery package chain Pn to be compactly coiled, folded, or stored in a relatively small bin or reel within delivery vehicle T (or warehouse) prior to loading into feed tape mechanism 20, 21, 22 and subsequent delivery to drone platform 60.

In operation, delivery package chain Pn is advanced by feed tape mechanism 20, 21, 22 (which may engage either the feed apertures 14 or the outer edges of the feed tape 12 as described in other embodiments). As lead delivery package P1 is propelled toward the drone platform 60, partial severances 12.4 allow the chain to smoothly negotiate any turns, vertical rises (such as the ceiling-feed configuration of FIG. 2A), or transitions within the vehicle interior. Once lead package P1 reaches drone platform 60 and is captured by drone feed tape capture system 140 of drone 100, the microprocessor/controller 40 activates the tape cutter 50 to fully sever the feed tape 12 at the appropriate location, thereby releasing only the individual delivery package P1 while the remainder of the delivery package chain Pn (still flexibly connected by the intact feed tape 12 and partial severances 12.4) remains ready for the next delivery cycle.

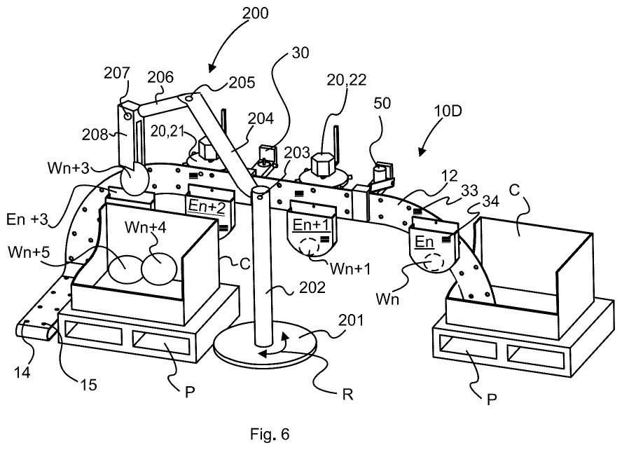

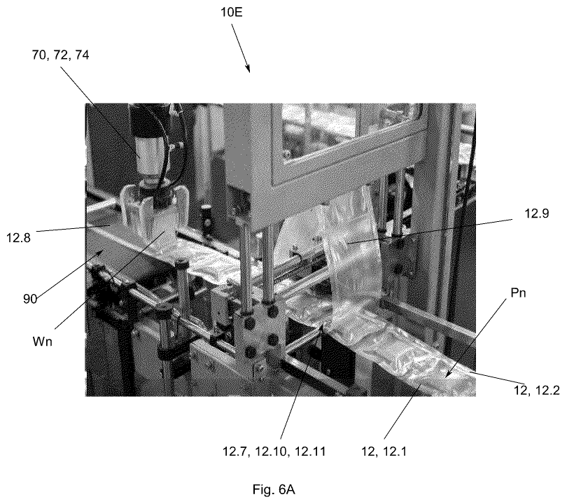

It is contemplated herein that the partial severance 12.4 may be formed as a laser cut, die cut, or pre-perforated line during the warehouse filling and sealing process (see FIGS. 6, 6A), and that the depth and spacing of the partial severance 12.4 may be varied according to package size, weight, or route requirements while always preserving the structural integrity of at least one outer edge(s), first outer edge 12.1 and second outer edge 12.2, of package feed tape 12. The double-sealed construction of the feed tape 12 further ensures that the delivery items Wn remain fully protected and tamper-evident until final tape cutter 50 operation.

The hinged delivery package chain Pn design provides several distinct advantages over prior rigid or fully severed package arrays. First, the ability to flex and hinge allows the chain to be stored in a compact bin or reel configuration inside delivery vehicle T, dramatically increasing the number of pre-sequenced packages that can be carried on a single route. Second, the arcuate feeding capability enables the feed tape mechanism 20, 21, 22 to be positioned in space-constrained areas of the truck (including vertical or curved routing through the ceiling C), reducing the overall footprint of package handling system 10. Third, the hinged flexibility minimizes stress on the packages during transport and feeding, thereby reducing the risk of damage to the delivery items Wn. All of these benefits are achieved while maintaining the precise sequential order required for GPS-controlled, automated drone delivery as described throughout the present disclosure.

This embodiment of delivery package P1 and delivery package chain Pn is fully compatible with all other aspects of package handling system 10, including the battery handling system 10C, the envelope filling system 10D, drone platform 60 with spaced landing pads 61, 62, and the through-ceiling feed configuration previously described. The hinged, partially severed package chain Pn therefore further advances the objects of the disclosure by enabling even more efficient, space-saving, and reliable last-mile drone delivery of packages.

It is contemplated herein that continuous delivery package chain Pn may be formed of filament or sheet of paper or poly material.

Referring now to FIG. 2C, there is illustrated an alternate preferred embodiment of the delivery package P1 and associated delivery package chain Pn of package handling system 10 of the present disclosure. In this embodiment, each individual delivery package Pn (containing a delivery item Wn) is formed as part of a continuous delivery package chain Pn in which a plurality of sealed packages Pn, Pn+1, Pn+2, . . . are affixed or integrated in series to a common package feed tape 12.The feature of the present embodiment is the provision of an access port to place delivery item Wn in delivery package Pn, such as envelope flap 12.6 integrally formed with or permanently attached to each sealed package Pn. As clearly shown in FIG. 2C, the envelope flap 12.6 extends or hinges preferably from the top edge, first outer edge 12.1 or upper layer 12.9 of each delivery package P1, Pn and is configured to function as a self-closing or re-sealable closure element. Prior to filling, envelope flap 12.6 is in an open or partially open position, providing direct access to the interior of delivery package P1, Pn while the entire delivery package chain Pn remains continuously connected to and propelled by package feed tape 12. After the delivery item W1, Wn is inserted (tion), envelope flap 12.6 may be folded downward, closed, enclosed. and sealed (by adhesive, heat sealing, ultrasonic welding, or other conventional sealing means) to fully enclose and protect delivery item W1, Wn, thereby converting open package into the final sealed package P1, Pn without ever detaching the package from feed tape 12 or breaking the continuity of the delivery package chain Pn.

It is contemplated herein that envelope flap 12.6 movable between (i) an open position that permits insertion of delivery item Wn directly into delivery package P1, Pn while delivery package P1, Pn remains continuously affixed to package feed tape 12 and (ii) a sealed position that fully encloses delivery item Wn within delivery package P1, Pn.

This envelope flap 12.6 design enables true self-fill capability of each delivery package Pn directly while the packages remain part of the delivery package chain Pn. During the self-fill, or warehouse or factory filling operation (see FIG. 6), feed tape mechanism 20, 21, 22 advances delivery package chain Pn in precise incremental steps so that each successive package Pn is positioned at the loading station. Person or robotic arm 200 (or an automated filling station) places the designated widget Wn (the customer-ordered delivery item associated with the next sequential delivery stop DS on the delivery route DR (predetermined delivery-route sequence)) into the package Pn, and then closes and seals the envelope flap 12.6. Because the envelope flap 12.6 is part of the package structure itself and does not require separation of individual packages from the chain, the entire filling sequence occurs continuously and automatically while the feed tape 12 is being propelled through the envelope handling system 10C/10D. Machine-readable codes 33, 34 on feed tape 12 or each package Pn ensure that the correct widget Wn is placed into the correct package Pn according to the pre-determined delivery-route sequence.

It is contemplated herein that envelope flap 12.6 may incorporate a pressure-sensitive adhesive strip, a resealable zipper, or a heat-sealable coating along its sealing edge to permit rapid, reliable closure after filling. Flap 12.6 may also be pre-scored or pre-creased to facilitate precise folding and alignment during the automated sealing step. The sealed construction of the package body combined with envelope flap 12.6 further ensures that each delivery item Wn remains tamper-evident and protected from environmental exposure throughout storage, transport, and final drone delivery.

Envelope flap 12.6 self-fill delivery package chain Pn design provides several distinct advantages over conventional separate-envelope, baggers, or rigid-package systems. First, it allows the entire delivery package chain Pn to be filled in a single continuous pass through the filling station without ever breaking the chain or requiring individual package handling, dramatically increasing throughput and eliminating sequencing errors. Second, because the packages remain affixed to feed tape 12 at all times, the precise delivery-route order is preserved from the moment of filling through final drone delivery to the customer porch or designated drop location. Third, the hinged flexibility of envelope flap 12.6 (in combination with any severances 12.4 as described in other embodiments) permits the filled chain to be coiled, folded, or stored compactly in a bin or reel inside delivery vehicle T prior to deployment on drone platform 60. All of these benefits are achieved while maintaining full compatibility with feed tape mechanism 20, 21, 22, tape cutter 50, drone feed tape capture system 140, spaced-apart drone landing pads 61, 62, and through-ceiling feed configuration previously described.

This embodiment of the delivery package P1 and delivery package chain Pn incorporating envelope flap 12.6 therefore further advances the objects of the disclosure by enabling fully automated or self-fill, high-speed, sequence-preserving of packages directly on feed tape 12, thereby reducing manpower costs in the warehouse or store, minimizing handling errors, and supporting the overall goal of efficient truck-to-drone last-mile delivery as contemplated throughout the present disclosure. Envelope flap 12.6 self-fill system is fully interchangeable with the other package and battery handling embodiments described herein and may be utilized in any combination with the hinged chain features of FIG. 2B or the through-ceiling feed features of FIG. 2A. Referring now to FIGS. 1, 4A, and 4B, there is illustrated a preferred embodiment of one or more package handling system 10, one or more delivery platforms 60, and one or more drone 100. Drone 100 may include drone microprocessor or controller 40 to control navigation of drone 100 and communicate with delivery microprocessor or controller 40, preferably for short haul delivery of package Pn to address of delivery stops DS of delivery route DR of delivery truck T. Drone 100 may include body 110, landing structure(s) 120 connected to body 110 and two or more drive motors with power supplies and lift and guidance propellers 130 to navigate drone 100. Moreover, drone 100 may include drone feed tape capture system 140, such as slotted feed tape receiver, preferably affixed to body 110 or landing structure(s) 120. Drone feed tape capture system 140 may include a slotted tape receiver, such as gapped or spaced apart first receiver member 141 and second receiver member 142 with catch pin 145 or the like to insert therein feed tape apertures 14 of feed tape 12 or secure feed tape 12 therein to secure package Pn to drone feed tape capture system 140 of drone 100 for transport and drop off to delivery stops DS of delivery route DR of delivery truck T.

First step, drone 100 lands on drone pad 60 as shown in FIG. 1. Delivery microprocessor or controller 40 detects drone 100 is in positions on drone platform 60 or drone 100 communicates same to delivery microprocessor or controller 40. Next step, package handling system 10 feeds or moves package feed tape 12 through feed tape mechanism 20 and feed tape mechanism 20 moves or pushes or pulls package feed tape 12 to drone platform 60 and preferably between pair of spaced apart landing pads 61, 62 into drone feed tape capture system 140. Where drone feed tape capture system 140 grips or slides catch pin 145 in to feed tape apertures 14 of package feed tape 12 to secure package Pn to drone feed tape capture system 140 of drone 100.

Drone 100 communicates to delivery microprocessor or controller 40 of package handling system 10 that feed tape and delivery package Pn is secure in drone feed tape capture system 140. Delivery microprocessor or controller 40 initiates tape cutter 50 to cut, separate, release, or sever, for example, package Pn from Pn+1, Pn+2, Pn+3, Pn+4, Pn+5, Pn+6, Pn+7 and so on.

Drone 100 transports package Pn to addressed delivery location, delivery stops DS of delivery route DR from delivery truck T via drone navigation algorithm, such as navigation to front door, garage (drone trigger garage to open & close), porch, drop box, or other designated delivery location and releases catch pin 145 to deposit package Pn there. Drone 100 navigates and returns to drone platform 60 to pick up package Pn+1 next. Delivery truck T moves to next address location Pn+1. Repeat for Pn+2, Pn+3, Pn+4, Pn+5, Pn+6, Pn+7 and so on in sequence (delivery stop sequence).

Referring now to FIGS. 5, 5A, and 5B, there is illustrated a preferred embodiment of one or more battery handling system 10C, one or more delivery platforms 60, and one or more drone 100. Battery handling system 10C having manned or unmanned delivery vehicle, such as delivery truck T transporting one or more drone battery packs, such as battery Bn, Bn+1, Bn+2 and so on affixed or removeably affixed in series to battery feed tape 12. Each battery B may contain machine readable code 34, such as bar code or RFID tag that can be scanned by code reader, such as battery reader 30, 32 and transmitted to microprocessor or controller 40 to control power supply to drone 100. Moreover, batteries Bn may be wired (electrically connected) together via wires 512 running along battery feed tape 12 to enable trickle charging via charger 510 so battery Bn, Bn+1, Bn+2 and so on remain in a state of full charge.

Drone 100 may include microprocessor or controller 40 to control(s) to control navigation of drone 100, short haul delivery of package Pn to address and communicate with delivery truck T. Drone 100 may include body 110, landing structure(s) 120 connected to body 110 and two or more drive motors and lift and guidance propellers 130 to navigate drone 100. Drone 100 may connect to auxiliary power, such as via charger 510 via platform 60 when docking. Moreover, drone 100 may include one or more drone battery feed tape capture system 240 preferably affixed to body 110 or landing structure(s) 120. Drone battery feed tape capture system 240 may include at least one battery receiver, or such as spaced apart first battery receiver 241 and second battery receiver 242 with catch pin 245 or the like to insert therein feed apertures 14 of battery feed tape 12 to secure battery Bn to drone feed tape capture system 140 (slotted battery receiver) of drone 100. It is contemplated at least one battery receiver, or such as spaced apart first battery receiver 241 and second battery receiver 242 may include receiver slot 246 to receive battery feed tape 12.

First step, drone 100 lands on drone pad 60 as shown in FIG. 1. Microprocessor or controller 40 detects drone 100 is in positions on drone platform 60 or drone 100 communicates same to microprocessor or controller 40 that drone power is low (low power). Next step, battery handling system 10C feeds, pushes or pulls, or moves battery feed tape 12 through battery feed tape mechanism 20 and battery feed tape mechanism 20 moves or pushes or pulls battery feed tape 12 to drone platform 60 and preferably into or through drone battery feed tape capture system 240. Where drone battery feed tape capture system 240 grips or slides catch pin 245 into feed tape apertures 14 of battery feed tape 12 to secure battery Bn to drone battery feed tape capture system 240 of drone 100 to supply drone 100 with newly charged battery system. Spent battery Bn−1 is pushed from at least one battery receiver, drone battery feed tape capture system 240, or such as spaced apart first battery receiver 241 and second battery receiver 242 and drops spent battery Bn−1 into catch bin 70 positioned below drone platform 60.

It is contemplated herein that drone 100 may have two or more batteries Bn and that drone 100 may service one set and then rotate thereon platform 60 to enable service of other set(s) of batteries Bn. Furthermore, first battery receiver 241 and second battery receiver 242 may be formed to make a partial or full enclosure therearound battery Bn.

It is contemplated herein that drone 100 may have two or more batteries Bn and that drone 100 may service two or more batteries Bn simultaneously via two battery handling system 10C.

Drone 100 communicates to microprocessor or controller 40 of package handling system 10 that battery feed tape 12 and delivered battery Bn is secure in drone battery feed tape capture system 240. Microprocessor or controller 40 initiates tape cutter 50 to cut, separate, release, or sever, for example, battery Bn from batteries Bn+1, Bn+2, on battery feed tape 12 and so on.

Drone 100 returns to service to transports package Pn to addressed delivery location via drone navigation algorithm, such as navigation to front door, garage (drone trigger garage to open & close), porch, drop box, or other designated delivery location and releases catch pin 145 to deposit package Pn. Drone 100 navigates and returns to drone platform 60 to pick up package Pn+1. Delivery truck T moves to next address location Pn+1. Repeat.

It is contemplated herein that battery handling system 10C may be independent of delivery truck T and be one or more standalone battery exchange station for one or more drones 100. Such system may be utilized in a factory, warehouse, shipping department, on a separate delivery truck T, spaced apart stations in specified areas (city) or campus, farm, ranch, business, or the like.

Referring now to FIG. 6, there is illustrated a preferred embodiment of envelope handling system 10C having one or more envelopes E or one set of delivery envelopes E such as delivery envelopes En, En+1, En+2, En+3, and so on affixed or removeably affixed in series to envelope feed tape 12 for transport to individual addresses or delivery stops DS of delivery route DR of delivery truck T. Each envelop E may contain an address or a machine readable code 34, such as bar code or RFID tag that can be scanned by code reader, such as package reader 30 and transmitted to microprocessor or controller 40 to control loading of widgets W into envelope E to become packages Pn. It is contemplated herein that addressed envelope E, of one or more envelopes E or one set of delivery envelopes E such as delivery envelopes En, En+1, En+2, En+3, and so on, may include an address or machine readable code 34 associated with a delivery address in a sequence of delivery stops DS of delivery route DR of delivery truck T(delivery stop sequence).

Envelope handling system 10C may include drones 100 or robotic devices, such as robotic arm 200 having base 201, vertical extension arm 203 to raise and lower gripper hand 208 as well as rotate gripper hand 208 about rotation R, one or more extension arms, such as first extension arm 204 pivotably connected to vertical extension arm 202, and second extension arm 206 pivotably connected to first extension arm 204 to enable precise positioning of gripper hand 208, and gripper hand 208 rotationally connected to second extension arm 206 to enable identification, such as (selecting a product, such as widget Wn ordered by a customer with address or machine readable code 34 associated with a delivery address in a sequence of delivery stops DS of delivery route DR of delivery truck T) and picking of designated widget(s) Wn from container C (on a palate) or conveyor belt and placing designated widget(s) Wn in envelope En as feed tape 12 traverses its course to form package(s) Pn.

Delivery stops Dn corresponds to envelope En having therein widget Wn to form package Pn positioned on feed tape 12 for delivery in sequence to address An corresponding to delivery stops DS of delivery route DR of delivery truck T.

It is contemplated herein that robotic arm may be a drone, robot, or like unmanned widget Wn picker.

Envelope handling system 10C may utilize robotic arm 200 to pick designated widget Wn associated with delivery address in a sequence of delivery stops DS of delivery route DR of delivery truck T and place designated widget Wn in envelope En of one or more envelopes En, En+1, En+2, En+3, and so on to form delivery package Pn in a sequence of delivery packages Pn, Pn+1, Pn+2, Pn+3, Pn+4, Pn+5, Pn+6, Pn+7 affixed to tape feed 12 according to a sequence of delivery stops DS of delivery route DR of delivery truck T (delivery stop sequence). Next, feed tape mechanism 20 propels feed tape 12 and one or more envelopes En to position next envelope En+1 from one or more envelopes En+1, En+2, En+3 and so on proximate or close in distance robotic arm 200. Robotic arm 200 picks next designated widget Wn+1 associated with a next delivery address in a sequence of delivery stops DS of delivery route DR of delivery truck T and places next designated widget Wn+1 in an envelope En+1 from one or more envelopes En+1, En+2, En+3 and so on to form a next delivery package Pn+1 in a sequence of delivery packages Pn, Pn+1, Pn+2, Pn+3, Pn+4, Pn+5, Pn+6, Pn+7 and so on. Repeat to form in sequence delivery packages Pn, Pn+1, Pn+2, Pn+3, Pn+4, Pn+5, Pn+6, Pn+7 associated with a series of delivery address in a sequence of delivery stops DS of delivery route DR of delivery truck T (delivery stop sequence).

Referring now to FIG. 6A, there is illustrated an alternate preferred embodiment of the package chain equipment 10E of the feed tape and delivery package fill system of the present disclosure. In this embodiment, the continuous delivery package chain Pn (having delivery packages Pn, Pn+1, Pn+2, . . . each containing a respective delivery item or widget Wn) is formed in-line and automatically by the package chain equipment directly on a continuously advancing conveyor system.

Package chain equipment 10E utilizes conveyor 90 that traverses or transports a first filament or sheet of paper or poly material or rolls of same, illustrated as lower layer 12.8. Lower layer 12.8 serves as the base web of the eventual package feed tape 12 and is advanced in a controlled, incremental manner beneath robotic arm suction head 70, 74 of robotic arm 70, 72. As lower layer 12.8 moves along conveyor 90, robotic arm 70, 72 (equipped with a suction head 70, 74) precisely picks, orients, and places each designated delivery item Wn (the customer-ordered widget associated with the next sequential delivery stop DS on delivery route DR) onto lower layer 12.8 in exact registration with the pre-determined delivery sequence. Machine-readable codes 33, 34 on lower layer 12.8 (or previously printed thereon) ensure that correct widget Wn is deposited into the correct position for each successive package Pn.

Immediately thereafter, an upper layer 12.9 (a second filament or sheet of packaging or a folded or fold over lower layer 12.8) may be positioned over the item-laden lower layer 12.8. Upper layer 12.9 and lower layer 12.8 are then brought into intimate contact and joined by heat-sealing, gluing, or the like, such as seal station 12.7 (or equivalent sealing means such as ultrasonic welding, adhesive, or mechanical crimping) that extends around the periphery of each delivery item Wn, thereby forming a fully sealed, individual delivery package Pn while the entire assembly remains part of the continuous web. Seal station 12.7 simultaneously defines the body of each sealed package and integrates the structure into the package feed tape 12. A key aspect of the present embodiment is that the package chain equipment 10E may additionally forms severance 12.4 via cut station 12.10 (as previously described in connection with FIG. 2B) between each adjacent sealed package Pn and Pn+1. Severance 12.4 may be created or performed by a precision cutting station 12.10 (laser cutter, a die-cut station, and a perforating station) integrated into the equipment and may extend inwardly from the newly formed outer edges, first outer edge 12.1 and second outer edge 12.2 of package feed tape 12 but terminates precisely at or immediately adjacent the central feed tape portion, preferably leaving outer edges first outer edge 12.1 and second outer edge 12.2 completely intact and continuous along the full length of the delivery package chain Pn. These continuous outer edges, first outer edge 12.1 and second outer edge 12.2 (together with the intact central feed tape region which may contain feed tape apertures 14 via perforating station 12.11) provide the structural backbone that enables the hinged flexibility and arcuate feeding capability of the entire chain, as described in earlier embodiments.

It is contemplated herein that seal station 12.7 may join upper layer 12.9 and lower layer 12.8.

The result is a fully formed, pre-sequenced delivery package chain Pn in which each delivery package Pn, Pn+1 . . . is (i) filled with the correct widget Wn, Wn+1 . . . according to the delivery route DR, (ii) hermetically sealed by seal station 12.7 between lower layer 12.8 and upper layer 12.9, and (iii) flexibly connected to the adjacent packages via severance 12.4 while the outer edges, first outer edge 12.1 and second outer edge 12.2 remain continuous. The completed package chain Pn exits the package chain equipment 10E ready for immediate loading into the feed tape mechanism 20, 21, 22 (or for compact coiling/storage in a bin or reel within delivery vehicle T). It is contemplated herein that the conveyor 90, robotic arm 72, film feed stations, heat-seal station, and severance station of package chain equipment 10E are all synchronized under control of microprocessor/controller 40 and guided by the machine-readable codes 33, 34 so that the entire formation, filling, sealing, and chain-definition process occurs in a single continuous, synchronized, high-speed pass. Lower layer 12.8 and upper layer 12.9 may be supplied from rolls of suitable packaging film (transparent, opaque, tamper-evident, or plastic film, paper sheeting, and the like or otherwise) and may incorporate pre-printed labels, bar codes, or RFID tags as required.

It is contemplated herein that synchronizing the forming continuous sealed delivery package chain Pn of designated delivery items Wn for drone delivery with controller 40 that ensures correct sequential placement of each of the designated delivery items on lower layer 12.8.

The in-line package chain equipment 10E utilizing lower layer 12.8, robotic placement or insert of delivery item Wn, overlay of upper layer 12.9, seal station 12.7 seals feed tape 12, and simultaneous formation of partial severance 12.4 via cut station 12.10 together with continuous outer edges, first outer edge 12.1 and second outer edge 12.2 of provides several distinct advantages. First, it enables fully automated, error-free creation of the sequenced delivery package chain Pn directly from bulk widgets and raw film stock, eliminating separate envelope stuffing or manual packaging steps. Second, the continuous outer edges, first outer edge 12.1 and second outer edge 12.2 combined with severance 12.4 impart the hinged flexibility necessary for arcuate feeding, compact storage, and smooth passage through feed tape mechanism 20, 21, 22 and any ceiling aperture C (FIG. 2A). Third, the entire chain remains affixed to the integral package feed tape 12 from the moment of formation through final drone capture, preserving perfect route sequence and eliminating any possibility of mis-sorting.

This embodiment of the package chain equipment 10E is fully compatible with all other aspects of the package handling system 10, including the through-ceiling feed configuration of FIG. 2A, the hinged delivery package chain of FIG. 2B, the envelope flap self-fill design of FIG. 2C, drone platform 60 with spaced landing pads 61, 62, drone feed tape capture system 140, battery handling system 10C, and the overall truck-to-drone delivery workflow. Package chain equipment 10E therefore further advances the objects of the disclosure by providing a complete, high-throughput, automated solution for creating the pre-sequenced delivery package chain Pn that powers the efficient, low-manpower, last-mile drone delivery system contemplated throughout the present disclosure.

For example, industry delivery package Pn autobaggers and wrappers may be adapted to form the continuous delivery package chain Pn of the present disclosure by utilizing its lower-reel film feed system to supply lower layer 12.8 (base web) directly onto the belted infeed conveyor, where the robotic arm 70, 72 (or an integrated product placer synchronized with the machine's servo controls) precisely positions each delivery item Wn in registration with the pre-printed machine-readable codes 33, 34 in a sequence of a delivery route DR. Lower layer 12.8 may be placed, rolled or drawn over the item-laden lower layer 12.8 to form upper layer 12.9; end-seal station 12.7 and newly added longitudinal side-seal stations 12.7 then create hermetic seals 12.7 around each item Wn, simultaneously defining the sealed package bodies while leaving continuous, unsevered ends to form the combined film web that becomes continuous delivery package chain Pn. Moreover, newly added longitudinal side-seal stations may be utilized to form continuous outer edges, first outer edge 12.1 and second outer edge 12.2 of structural package feed tape 12 (optionally incorporating feed apertures 14 via an added perforating station 12.11). Rather than employing the standard full-separation cut-off knife, cut-off station 12.10 may be modified (via software-controlled servo timing and a custom partial-cut die, laser station, or the like) via cut station 12.10 to produce severance 12.4 (slit or perforated) between adjacent packages—preferably extending inwardly from the newly formed outer edges, first outer edge 12.1 and second outer edge 12.2 via one or more added longitudinal side-seal(s) to form structural package feed tape 12 but terminating short of the central feed-tape region (first outer edge 12.1 and second outer edge 12.2)—thereby preserving the hinged, continuous delivery package chain Pn that can flex, coil, and advance smoothly through feed tape mechanism 20, 21, 22 and ceiling aperture C as contemplated throughout package handling system 10. This adaptation leverages the 650SI's high-speed servo precision (up to 80 packs/min), wide film capacity, and recyclable-paper compatibility while requiring only tooling and programming changes to achieve the novel in-line formation of the sequenced, hinged package chain directly from bulk film and widgets.

It is contemplated herein that cut station 12.10, perforating station 12.11, and seal station 12.7 may occur in the same location.

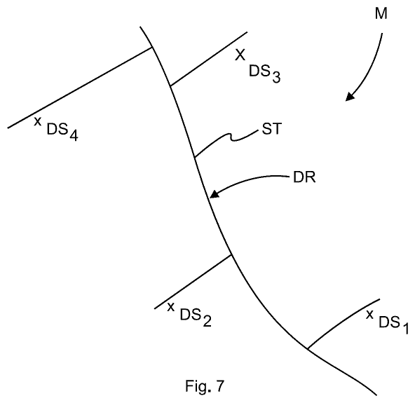

Referring now to FIG. 7, there is illustrated a preferred embodiment of a map M of a delivery route DR having a series of delivery stops DSn (DS1) for delivery of package Pn containing widget Wn, DSn+1(DS2) for delivery of package Pn+1 containing widget Wn+1, DSn+2(DS3) for delivery of package Pn+2 containing widget Wn+2, DSn+3(DS4) for delivery of package Pn+3 containing widget Wn+3 (addresses) associated with designated delivery packages Pn, Pn+1, Pn+2, Pn+3, having delivery contents, such as widgets Wn, Wn+1, Wn+2, Wn+3, ordered by customers Cn, Cn+1, Cn+2, and Cn+3 associated with the series of delivery stops DS of delivery route DR of delivery truck T.

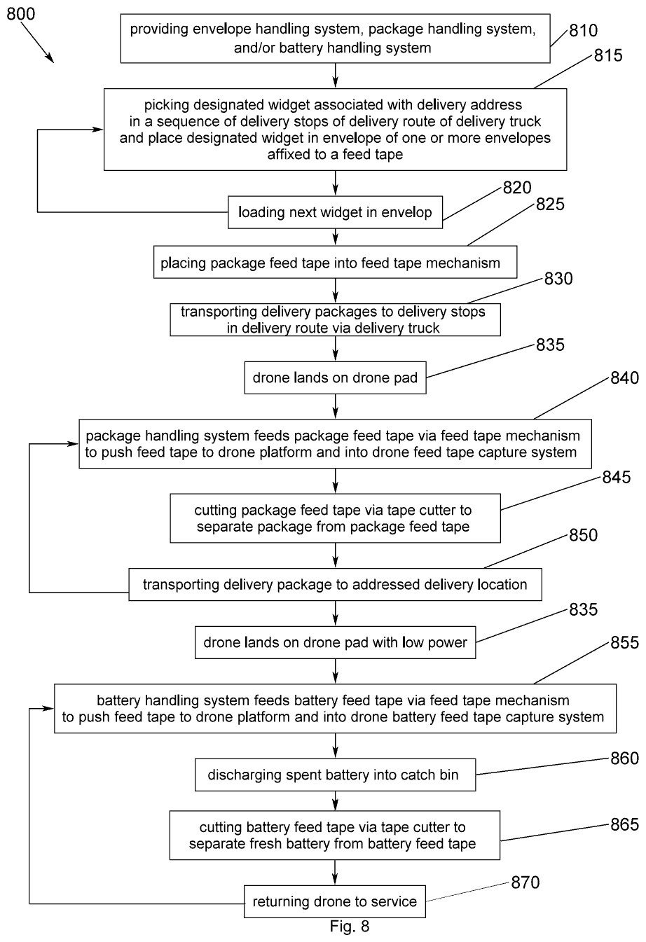

Referring now to FIG. 8, there is illustrated a flow diagram 800 of a method of operation and use of envelope handling system 10D, package handling system 10, package handling system 10B, and/or battery handling system 10C. In block or step 810, providing envelope handling system 10D, package handling system 10, package handling system 10B, and/or battery handling system 10C as described above in FIGS. 1-7. In block or step 815, utilizing robotic arm 200 to pick(ing) designated widget Wn associated with delivery address in a sequence of delivery stops DS of delivery route DR of delivery truck T and place designated widget Wn in envelope En of one or more envelopes En, En+1, En+2, En+3, and so on to form delivery package Pn in a sequence of delivery packages Pn, Pn+1, Pn+2, Pn+3, Pn+4, Pn+5, Pn+6, Pn+7 affixed to package tape feed 12 according to a sequence of delivery stops DS of delivery route DR of delivery truck T. In block or step 820, loading next widget Wn+1 in envelope En+1 and repeat until delivery packages Pn, Pn+1, Pn+2, Pn+3, Pn+4, Pn+5, Pn+6, Pn+7 have been filled (delivery stop sequence).

In block or step 825, placing package feed tape 12 into feed tape mechanism 20, 21, 22 and configured to drive, push and pull, or move (to propel) package feed tape 12 in preferably linear motion toward drone platform 60.

In block or step 830, transporting delivery packages Pn, Pn+1, Pn+2, Pn+3, Pn+4, Pn+5, Pn+6, Pn+7 to delivery stops DS in delivery route DR of delivery truck T, such as delivery stops DSn (DS1) for delivery of package Pn containing widget Wn.

In block or step 835, landing drone 100 on drone platform 60.

In block or step 840, picking delivery packages Pn via package handling system 10 feeds or moves package feed tape 12 through feed tape mechanism 20 and feed tape mechanism 20 moves or pushes or pulls package feed tape 12 to drone platform 60 and preferably between pair of spaced apart landing pads 61, 62 into drone feed tape capture system 140. Where drone feed tape capture system 140 grips or slides catch pin 145 in to feed tape apertures 14 of package feed tape 12 to secure package Pn to drone feed tape capture system 140 of drone 100.

In block or step 845, cutting package feed tape 12 via tape cutter 50 to cut, separate, or sever, for example, delivery package Pn from Pn+1, Pn+2, Pn+3, Pn+4, Pn+5, Pn+6, Pn+7 and so on.

In block or step 850, transporting delivery package Pn to addressed delivery location, delivery stops DS of delivery route DR from delivery truck T via drone 100 carrying delivery package Pn to addressed delivery location, delivery stops DS of delivery route DR from delivery truck T. Repeat for Pn+1, Pn+2, Pn+3, Pn+4, Pn+5, Pn+6, Pn+7 and so on (delivery stop sequence).

In block or step 835, landing drone 100 on drone platform 60.

In block or step 855, loading fresh battery into drone 100 via battery handling system 10C feeds, pushes or pulls, or moves battery feed tape 12 through feed tape mechanism 20 and feed tape mechanism 20 moves or pushes or pulls battery feed tape 12 to drone platform 60 and preferably into or through drone battery feed tape capture system 240.

In block or step 860, discharging spent battery into catch bin via spent battery Bn−1 is pushed from at least one battery receiver, drone battery feed tape capture system 240, or such as spaced apart first battery receiver 241 and second battery receiver 242 and drops spent battery Bn−1 into catch bin 70 positioned below drone platform 60.

In block or step 865, cutting battery feed tape 12 via tape cutter 50 to cut, separate, release, or sever, for example Bn from Bn+1, Bn+2 and so on. Repeat for Bn+1, Bn+2 and so on.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A flexible continuous delivery package chain for automated drone delivery, said chain comprising:
a plurality of sealed delivery packages affixed in series to a package feed tape to form the continuous delivery package chain, said package feed tape having a first outer edge and a second outer edge, each extending unbroken along a full length of the chain; and
a severance formed between each adjacent pair of delivery packages, said severance extending inwardly from proximate said first outer edge toward proximate said second outer edge, thereby creating a hinge at each inter-package junction, whereby said delivery package chain is able to flex, hinge, and follow an arcuate path without separation of individual packages.

2. The delivery package chain of claim 1, wherein said severance is selected from a laser cut, die cut, and pre-perforated line.

3. The delivery package chain of claim 1, wherein said package feed tape further comprising a series of feed tape apertures located linearly in said first outer edge and said second outer edge.

4. The delivery package chain of claim 1 in combination with a feed tape mechanism configured to engage said first outer edge and said second outer edge to propel said chain through a feed path.

5. The delivery package chain of claim 1 in combination with a robotic arm synchronized with a feed tape mechanism, said robotic arm inserts a designated widget associated with a next sequential delivery stop into each successive delivery package while said chain is advanced by said package feed tape.

6. A self-fill delivery package chain for automated drone delivery, said chain comprising:
a plurality of delivery packages affixed in series to at least one package feed tape to form a continuous delivery package chain; and each plurality of said delivery packages having an integrally formed envelope flap extending from an edge of said each plurality of delivery packages, said envelope flap movable between (i) an open position that permits insertion of a delivery item directly into said package while said package remains continuously affixed to said package feed tape and (ii) a sealed position that fully encloses said delivery item within said each plurality of said delivery packages, whereby said chain enables self-fill of each successive each plurality of said delivery packages without breaking continuity of said delivery of the delivery package chain.

7. The self-fill delivery package chain of claim 6, wherein said envelope flap further comprising a sealing mechanism is selected from heat-sealable coating, and pressure-sensitive adhesive, resealable closure along a sealing edge thereof.

8. The self-fill delivery package chain of claim 6, wherein said envelope flap is pre-creased or pre-scored to facilitate precise folding and alignment during automated or manual sealing.

9. The self-fill delivery package chain of claim 6, in combination with a feed tape mechanism configured to engage said package feed tape to propel the delivery package chain through a feed path.

10. The self-fill delivery package chain of claim 5 in combination with a robotic arm synchronized with a feed tape mechanism, said robotic arm inserting a designated widget associated with a next sequential delivery stop into each successive delivery package while the delivery package chain is advanced by said feed tape mechanism.

11. A package chain equipment for in-line formation of a continuous sealed delivery package chain of designated delivery items for automated drone delivery, said equipment comprising:
a conveyor transports a lower layer that forms a base web of the continuous sealed delivery package chain;
a robotic arm positioned above said conveyor, said robotic arm configured to pick and place each of the designated delivery items onto said lower layer corresponding to a predetermined delivery-route sequence;
position an upper layer over the delivery item-laden said lower layer;
a seal station that joins said upper layer to said lower layer around each delivery item to form the continuous delivery package chain while the delivery package chain remains part of a continuous web; and
said seal station joins said upper layer to said lower layer to form a first outer edge and a second outer edge of a package feed tape.

12. The package chain equipment of claim 11, further comprising a cut station that simultaneously forms a severance between each adjacent pair of the sealed delivery packages, said severance extending inwardly between said first outer edge and said second outer edge of said package feed tape, whereby said first outer edge, said second outer edge, and said severance provide structural integrity and hinged flexibility to the delivery package chain.

13. The package chain equipment of claim 12, further comprising a controller synchronized with said conveyor, said robotic arm, said seal station, and said severance station, said controller to ensure each designated delivery item is placed in order according to a delivery-route sequence.

14. The package chain equipment of claim 11, wherein said seal station creates peripheral heat seals that simultaneously define each package of the delivery package chain integrated with said package feed tape.

15. The package chain equipment of claim 12, wherein said severance station comprising a cutter selected from a laser cutter, a die-cut station, and a perforating station configured to produce said severance while preserving said first outer edge and said second outer edge of said package feed tape.

16. The package chain equipment of claim 11, wherein said lower layer and said upper layer are supplied from respective film rolls of packaging material selected from the group consisting of transparent film, opaque film, tamper-evident film, plastic film, paper sheeting, and combinations thereof.

17. A method of forming a continuous sealed delivery package chain of designated delivery items for drone delivery using package chain equipment, said method comprising the steps of:
advancing a lower layer along a conveyor, said lower layer serving as a base web of sealed delivery package chain;
robotically placing each designated delivery item onto said lower layer in a delivery-route sequence;
positioning an upper layer positioned over the item-laden lower layer;
sealing said upper layer to said lower layer around each delivery item to form the delivery package chain while maintaining web continuity; and
sealing said upper layer to said lower layer to form a first outer edge and a second outer edge of a package feed tape.

18. The method of claim 17, further comprising the step of forming a severance between each adjacent pair of the sealed delivery packages, said severance extending inwardly between said first outer edge and said second outer edge of said package feed tape, whereby said first outer edge, said second outer edge, and said severance provide structural integrity and hinged flexibility to the delivery package chain.

19. The method of claim 17, further comprising the step of synchronizing the forming a continuous sealed delivery package chain of designated delivery items for drone delivery with a controller that ensures correct sequential placement of each of the designated delivery items.

20. The method of claim 17, wherein said sealing step produces peripheral seals that both enclose each delivery item and integrate each package into the continuous sealed delivery package chain.

21. The method of claim 18, wherein said step of forming said severance is performed by a cut station selected from one of a laser, die, and perforating integrated into said package chain equipment.

22. The package chain equipment of claim 17 in combination with a delivery truck having an aperture, wherein the delivery package chain is advanced through said aperture to an exterior drone platform for capture by a drone feed tape capture system of a drone.
